(19) United States
(12) Patent Application Publication
(10) Pub. No.: US 2008/0063157 A1
(43) Pub. Date: Mar. 13, 2008

(54) INSTANT MESSAGING BUDDY LIST AUGMENTATION VIA AN INTERNET PROTOCOL (IP) TELEPHONY CALL DATA

(75) Inventors: Edward D. Doan, Round Rock, TX (US); James P. Galvin, Oak Ridge, NC (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/467,611

(22) Filed: Aug. 28, 2006

(51) Int. Cl. H04M 1/64

(52) U.S. Cl. 379/88.17

(57) ABSTRACT

Embodiments of the present invention address deficiencies of the art in respect to buddy list management and provide a method, system and computer program product for automatically adding new instant messenger buddies from conversational collaborators in an IP telephony session. In one embodiment of the invention, a buddy list augmentation method can be provided. The method can include receiving telephony call data for an IP telephony call with a collaborator, locating a screen name for the collaborator, and adding the located screen name to a buddy list for an instant messaging system. Optionally, the method further can include applying any or all of filtering, limiting and pruning rules to the screen name to determine whether or not to add the located screen name to the buddy list.

### BACKGROUND OF THE INVENTION

1. Field of the Invention

The present invention relates to the field of instant messaging and more particularly to the field of buddy list management in an instant messaging system.

2. Description of the Related Art

Real time communications systems provide a substantial enhancement over more traditional, asynchronous communications systems. Electronic mail delivery systems, the prototypical asynchronous communications systems, in its time represented a giant leap forward in respect to global interpersonal communications. Prior to electronic mail, individuals primarily communicated via telephone, facsimile and post. With electronic mail, however, individuals expect near instant delivery of text, and even imagery, audio and video, without incurring the delay typical of the postal system, or the expense associated with telephony and fax technologies.

Despite the ubiquity of electronic mail, asynchronous communications systems lack several elements common in the realm of real time communications systems. In particular, the seemingly instant delivery of a message cannot be experienced in the world of electronic mail. In a real-time society, the minor latencies associated with electronic mail often cannot be suitable for the task at hand where a real-time conversation will be required in addressing a problem or performing a collaborative task. More importantly, often the feel and nature of a “conversation” as it is known to human beings only can be approximated through real time communications where the participants to a conversation feel the spontaneity of an exchange of ideas, much as is the case in a live, face-to-face conversation.

The recent rapid development of the Internet has led to advanced modes of synchronous, real-time collaboration able to fulfill the real-time communicative requirements of the modern computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include several human-to-human collaborative environments including instant messaging.

Internet Protocol (IP) telephony provides an equally strong platform for spontaneous, real-time communications. In IP telephony, an end user calls a collaborator wherein the call at least is initiated within the infrastructure of a computer communications network though oftentimes, the call terminates in the public switched telephone network (PSTN). IP telephony users not only can utilize Voice over IP (VOIP) configured telephones similar in appearance and function to traditional telephones, but also IP telephony users can utilize soft phones implemented purely in software in a personal computing device.

In an instant messaging system, commonly used addresses for collaborative partners are stored and maintained in an address book referred to as a “buddy list”. New entries generally are added to the buddy list in only one of two ways: manually, or in response to receiving a chat request from another party. In either circumstance, however, the establishment of a subsequent conversation with the same collaborator can be as simple as locating the address of the collaborator in the buddy list and requesting the initiation of an instant messaging session with the collaborator.

Habitual users of instant messaging technologies are likely to utilize IP telephony when communicating with the same set of collaborators. IP telephony, like instant messaging, provides a facility for “speed dialing” frequently called collaborators. Generally stored in the form of a call log, this “buddy list” for IP telephony serves the same function as the buddy list for instant messaging. Notwithstanding, despite the commonality among its users, little has been done to leverage the knowledge of the frequency of IP telephony conversations among collaborators with the buddy list functionality of the instant messenger.

### BRIEF SUMMARY OF THE INVENTION

Embodiments of the present invention address deficiencies of the art in respect to buddy list management and provide a novel and non-obvious method, system and computer program product for automatically adding new instant messenger buddies from conversational collaborators in an IP telephony session. In one embodiment of the invention, a buddy list augmentation method can be provided. The method can include receiving telephony call data for an IP telephony call with a collaborator, locating a screen name for the collaborator, and adding the located screen name to a buddy list for an instant messaging system. Optionally, the method further can include applying any or all of filtering, limiting and pruning rules to the screen name to determine whether or not to add the located screen name to the buddy list.

In another embodiment of the invention, a collaborative communications system can be provided. The system can include an IP telephony server including an IP telephony gateway. The system further can include a call log for the IP telephony server. The system yet further can include an instant messaging system and a buddy list for the instant messaging system. Finally, the system can include IP telephony to buddy list logic. The logic can include program code enabled to augment the buddy list with screen names corresponding to entries in the call log. Optionally, the IP telephony to buddy list logic further can include additional program code enabled to locate the screen names from entries in the call log by searching one of a directory and a Web search engine.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative communications system configured for automatic buddy list augmentation through IP telephony call data; and,

FIG. 2 is a flow chart illustrating a process for automatic buddy list augmentation through IP telephony call data.

### DETAILED DESCRIPTION OF THE INVENTION

Embodiments of the present invention provide a method, system and computer program product for automatic buddy list augmentation through IP telephony call data. In accordance with an embodiment of the present invention, IP telephony call data can be captured from IP phone calls. The IP telephony call data can include caller identification data, called party identification data, an e-mail address of a called or calling party, a name of a called or calling party, or other such IP telephony call data. The IP telephony call data can be used in a directory search to locate a corresponding instant messaging screen name. Optionally, the located instant messaging screen name can be filtered. Thereafter, the located instant messaging screen name can be added to an instant messaging buddy list.

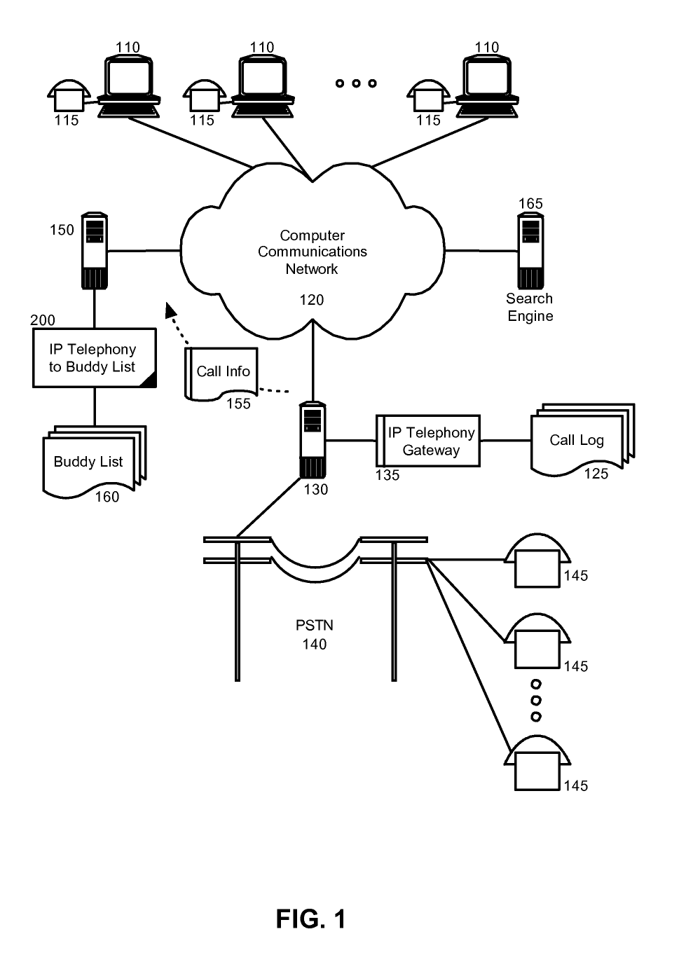

In further illustration, FIG. 1 is a schematic illustration of a collaborative communications system configured for automatic buddy list augmentation through IP telephony call data. The system can include one or more collaborative workstations 110 coupled to an IP telephony server 130 and an instant messaging server 150 over a computer communications network 120. The IP telephony server 130 can be configured with an IP telephony gateway 135 to a PSTN 140 and each of the collaborative workstations 110 can be configured with IP soft-phones or VOIP handsets 115 so that telephone calls can be established as between the collaborative workstations 110 and telephonic endpoints 145.

The instant messaging server 150 can be configured to support instant messaging sessions between the different collaborative workstations 110 and can include a buddy list 160 as is well known in the art. Notably, IP telephony to buddy list logic 200 can be coupled to the instant messaging server 150. The IP telephony to buddy list logic 200 can include program code enabled to augment the buddy list 160 through processing call information 155 provided by the IP telephony server 130 for telephone calls between the collaborative workstations 110 and the telephonic endpoints 145 (which also can include IP endpoints with others of the collaborative workstations 110).

Specifically, in one aspect of the invention, call information 155 can be extracted from a call log 125 for completed calls in the IP telephony server 130. The call information 155 can be robust in nature and can include full identifying information. Alternatively, the call information 155 can be limited and can include only an identifier for a called number or a calling number. In any case, utilizing the call information 155, the program code of the IP telephony to buddy list logic 200 can search a directory 165, for instance a lightweight directory assistance protocol (LDAP) directory or a Web search engine, for a screen name associated with the call information 155. Upon locating the screen name, the screen name can be added to the buddy list 160.

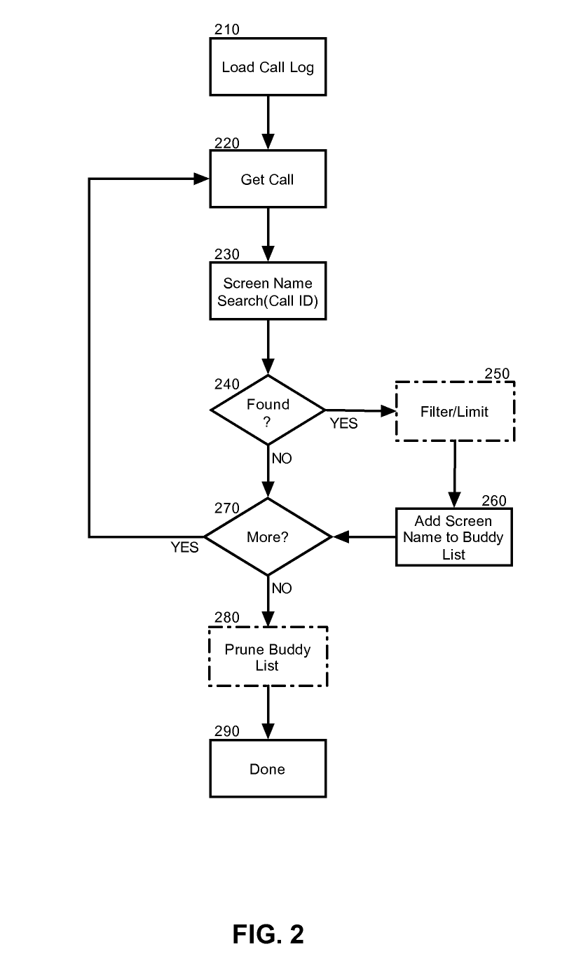

In further illustration of an exemplary aspect of the operation of the program code of the IP telephony to buddy list logic 200, FIG. 2 is a flow chart illustrating a process for automatic buddy list augmentation through IP telephony call data. Beginning in block 210, a call log for an IP telephony client can be loaded and IP telephony data for a first call can be retrieved from the call log in block 220. In block 230, the IP telephony call data can be used to search a database to locate a screen name for either the called party, or the calling party reflected within the IP telephony call data. In decision block 240, if a screen name can be located, the process can continue through block 250. Otherwise, in decision block 270, if additional calls remain to be processed in the call log, the process can repeat through block 220.

In block 250, as an optional step, the located screen name can be filtered and the addition of the screen name to a buddy list can be limited according to a set of rules. Filtering rules can include a white list or black list for the screen name, the mode of the telephone call including whether the call terminated on a PBX endpoint or on a VOIP endpoint, the time of day for the call, and so forth. Limiting rules, by comparison, can include whether a particular number of screen names already have been added from the call log, or whether some calls are prioritized over others according to the filtering rules such that less important calls do not have screen names added to the buddy list while more important calls do have screen names added to the buddy list.

Thereafter, in block 260 the screen name can be added to the buddy list (assuming that the screen name has not been limited or filtered from addition). In decision block 270, if additional calls in the call log remain to be processed, the process can repeat through block 220. When no more calls remain to be processed, optionally, in block 280 the buddy list can be pruned. Specifically, entries that have expired can be removed from the buddy list. The actually expiration of an entry can vary, however, according to rules such as whether the collaborator associated with the screen name has engaged in additional collaborations since having been added to the buddy list, whether the screen name is associated with a higher importance or a lower importance, whether the screen name is associated with an internal caller or an external caller, or whether the screen name is associated with a customer or a vendor, to name only a few rules. Once the buddy list has been pruned in block 280, the process can end in block 290.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A buddy list augmentation method comprising:
receiving telephony call data for a Internet Protocol (IP) telephony call with a collaborator;
locating a screen name for the collaborator; and,
adding the located screen name to a buddy list for an instant messaging system.

2. The method of claim 1, further comprising applying filtering rules to the screen name to determine whether or not to add the located screen name to the buddy list.

3. The method of claim 1, further comprising applying limiting rules to the screen name to determine whether or not to add the located screen name to the buddy list.

4. The method of claim 1, further comprising applying pruning rules to prune expired screen names from the buddy list.

5. The method of claim 1, wherein receiving the telephony call data for the IP telephony call with the collaborator comprises receiving one of caller identification data and called party identification data for the IP telephony call.

6. The method of claim 1, wherein locating a screen name for the collaborator comprises, searching a directory with the telephony call data to locate an associated screen name.

7. The method of claim 1, wherein locating a screen name for the collaborator comprises, searching a Web search engine with the telephony call data to locate an associated screen name.

8. The method of claim 2, wherein applying filtering rules to the screen name to determine whether or not to add the located screen name to the buddy list, comprises applying one of a white list and a black list to the located screen name to determine whether or not to add the located screen name to the buddy list.

9. The method of claim 4, wherein applying pruning rules to prune expired screen names from the buddy list, comprises:
determining whether additional collaborative communications have occurred with the collaborator; and,
removing expiration criteria from the located screen name for the collaborator if it is determined that additional collaborative communications have occurred with the collaborator.

10. A collaborative communications system comprising:
an Internet Protocol (IP) telephony server comprising an IP telephony gateway;
a call log for the IP telephony server;
an instant messaging system;
a buddy list for the instant messaging system; and,
IP telephony to buddy list logic comprising program code enabled to augment the buddy list with screen names corresponding to entries in the call log.

11. The system of claim 10, wherein the IP telephony to buddy list logic further comprises additional program code enabled to locate the screen names from entries in the call log by searching one of a directory and a Web search engine.

12. A computer program product comprising a computer usable medium embodying computer usable program code for buddy list augmentation, the computer program product including:
computer usable program code for receiving telephony call data for a Internet Protocol (IP) telephony call with a collaborator;
computer usable program code for locating a screen name for the collaborator; and,
computer usable program code for adding the located screen name to a buddy list for an instant messaging system.

13. The computer program product of claim 12, further comprising computer usable program code for applying filtering rules to the screen name to determine whether or not to add the located screen name to the buddy list.

14. The computer program product of claim 12, further comprising computer usable program code for applying limiting rules to the screen name to determine whether or not to add the located screen name to the buddy list.

15. The computer program product of claim 12, further comprising computer usable program code for applying pruning rules to prune expired screen names from the buddy list.

16. The computer program product of claim 12, wherein the computer usable program code for receiving the telephony call data for the IP telephony call with the collaborator comprises computer usable program code for receiving one of caller identification data and called party identification data for the IP telephony call.

17. The computer program product of claim 12, wherein the computer usable program code for locating a screen name for the collaborator comprises computer usable program code for searching a directory with the telephony call data to locate an associated screen name.

18. The computer program product of claim 13, wherein the computer usable program code for locating a screen name for the collaborator comprises computer usable program code for searching a Web search engine with the telephony call data to locate an associated screen name.

19. The computer program product of claim 13, wherein the computer usable program code for applying filtering rules to the screen name to determine whether or not to add the located screen name to the buddy list comprises computer usable program code for applying one of a white list and a black list to the located screen name to determine whether or not to add the located screen name to the buddy list.

20. The computer program product of claim 15, wherein the computer usable program code for applying pruning rules to prune expired screen names from the buddy list, comprises:
computer usable program code for determining whether additional collaborative communications have occurred with the collaborator; and,
computer usable program code for removing expiration criteria from the located screen name for the collaborator if it is determined that additional collaborative communications have occurred with the collaborator.
